(19) United States
(12) Patent Application Publication
(10) Pub. No.: US 2008/0270955 A1
(43) Pub. Date: Oct. 30, 2008

(54) METHOD AND APPARATUS FOR MODIFYING EXISTING CIRCUIT DESIGN

(76) Inventors: John Mack Isakson, Austin, TX (US); Jerry Don Lewis, Round Rock, TX (US); Thomas Edward Rosser, Austin, TX (US); Chin Ngai Sze, Austin, TX (US)

Correspondence Address: IBM CORP (YA);C/O YEE & ASSOCIATES PC, P.O. BOX 802333, DALLAS, TX, 75380, US

(21) Appl. No.: 11/741,440

(22) Filed: Apr. 27, 2007

(51) Int. Cl. G06F 17/50

(52) U.S. Cl. 716/5

(57) ABSTRACT

The illustrative embodiments provide a computer implemented method and apparatus for modifying an existing circuit design. For a modification in a design of a circuit, the circuit design tool receives a code describing the modification, and a design of the circuit. The design of the circuit includes a first design, which includes a design for a number of metallic layers in the circuit. The design of the circuit further includes a second design, which includes and a design for a number of non-metallic layers in the circuit. The circuit design tool identifies a set of hooks, a set of disconnected components, and a set of filler cells in the design of the circuit. The circuit design tool produces a modification design, which is implemented in a revision of the first design, using the code, and one or more of the hooks, the disconnected components, and the filler cells.

### BACKGROUND OF THE INVENTION

1. Field of the Invention

The present invention relates generally to an improved data processing system, and in particular, to a computer implemented method and apparatus for circuit design. Still more particularly, the present invention relates to a computer implemented method, apparatus, and computer-usable program code for modifying existing logic circuitry.

2. Description of the Related Art

Circuit designers use circuit synthesis software to design the circuits built into semiconductor chips. The design of the circuit takes into account the logic function that the circuit has to perform. The circuit designers specify the logical computation based on the inputs available, the outputs desired, and performance parameters within which the circuit is to perform.

Once a circuit design is ready, a set of logic components are available in what is known as a netlist. Logic components are smaller circuits that are capable of performing simple logical computations. Often, the simple logical function is a single logical operation. A logical operation is a mathematical function, for example, an AND, OR, NOT, NAND, NOR, XOR, and many other combinations of these functions. A set of logic components is one or more logic components.

A logic circuit performing one or more of the logical operations is also known as a gate. A gate array is a set of gates arranged in a particular manner. A set of gates is one or more gates.

A netlist is a collection and organization of the circuit components resulting from the design of the circuit according to the desired circuit function. The netlist may include logic components and other circuit components such as resistors and capacitors.

The testing and fabrication processes use the design of the circuit to finally produce a semiconductor chip. If the design, testing, and fabrication processes are all successful, the semiconductor chip should perform the designed function within the desired performance parameters.

### SUMMARY OF THE INVENTION

The illustrative embodiments provide a computer implemented method and apparatus for modifying an existing circuit design. A circuit design tool receives a request for a modification in a design of a circuit. Responsive to the request, the circuit design tool receives a code describing the modification. The circuit design tool receives a design of the circuit. The design of the circuit includes a first design, which includes a design for a number of metallic layers in the circuit. The design of the circuit further includes a second design, which includes and a design for a number of non-metallic layers in the circuit. The circuit design tool identifies a set of hooks in the design of the circuit. The circuit design tool identifies a set of disconnected components in the design of the circuit. The circuit design tool identifies a set of filler cells in the design of the circuit. The circuit design tool produces a modification design using the code, a subset of the set of hooks, a subset of the set of disconnected components, and a subset of the set of filler cells such that the modification design is implemented in a revision of the first design.

### BRIEF DESCRIPTION OF THE DRAWINGS

The appended claims set forth the novel features believed characteristic of the invention. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a data processing system, which an implementation of the illustrative embodiments may use;

FIG. 2 depicts a block diagram of a data processing system in which illustrative embodiments may be implemented;

FIG. 3 depicts a block diagram of circuit design and synthesis software in accordance with an illustrative embodiment;

FIG. 4 depicts a block diagram showing the manner of use of circuit design and synthesis software in accordance with an illustrative embodiment;

FIG. 5 depicts a block diagram of a manual process of modifying an existing circuit design that circuit designers presently use;

FIG. 6 depicts a block diagram of a modified circuit design and synthesis software in accordance with an illustrative embodiment; and

FIG. 7 depicts a flowchart of the process of modifying an existing circuit design in accordance with an illustrative embodiment.

### DETAILED DESCRIPTION OF THE PREFERRED EMBODIMENT

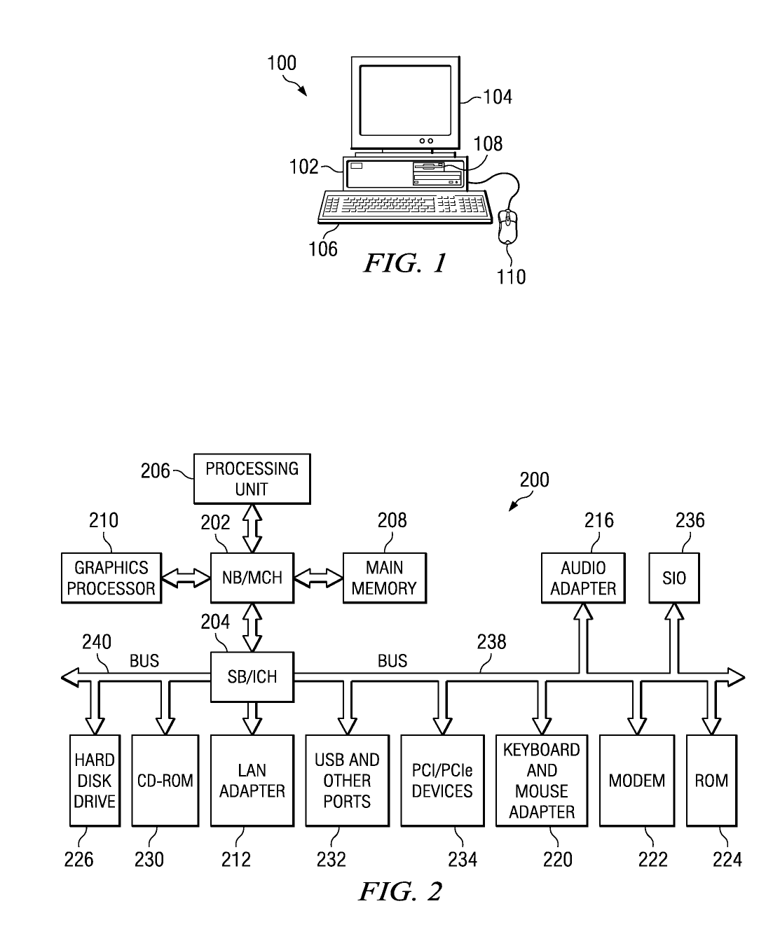

With reference now to the figures and in particular with reference to FIGS. 1 and 2, the figures provide exemplary diagrams of data processing environments, which an implementation of the illustrative embodiments may use. Note that FIGS. 1 and 2 are only exemplary and are do not assert or imply any limitation with regard to the environments in which different embodiments may be implemented. Specific implementations may make many modifications to the depicted environments.

With reference now to the figures and in particular with reference to FIG. 1, the figure depicts a pictorial representation of a data processing system, which an implementation of the illustrative embodiments may use. Computer 100 includes system unit 102, video display terminal 104, keyboard 106, storage devices 108, which may include floppy drives and other types of permanent and removable storage media, and mouse 110. Computer 100 also may contain additional input devices. Examples of additional input devices include, for example, a joystick, a touchpad, a touch screen, a trackball, and a microphone.

Computer 100 may be any suitable computer, such as an IBM® eServer™ computer or IntelliStation® computer, which are products of International Business Machines Corporation, located in Armonk, N.Y. Although the depicted representation shows a personal computer, other embodiments may use other types of data processing systems for implementation. For example, other embodiments may use a network computer for implementation. Computer 100 also includes systems software residing in computer-readable media in operation within computer 100 implementing a graphical user interface (GUI).

Next, FIG. 2 depicts a block diagram of a data processing system in which illustrative embodiments may be implemented. Data processing system 200 is an example of a computer, such as computer 100 in FIG. 1, which may contain the code or instructions implementing the processes of the illustrative embodiments.

In the depicted example, data processing system 200 employs a hub architecture, including a north bridge and memory controller hub (NB/MCH) 202 and a south bridge and input/output (I/O) controller hub (SB/ICH) 204. Processing unit 206, main memory 208, and graphics processor 210 couple to north bridge and memory controller hub 202. Processing unit 206 contains one or more processors and may use one or more heterogeneous processor systems for implementation. For example, an accelerated graphics port (AGP) may couple Graphics processor 210 to the NB/MCH through.

In the depicted example, local area network (LAN) adapter 212 couples to south bridge and I/O controller hub 204, audio adapter 216, keyboard and mouse adapter 220, modem 222, read only memory (ROM) 224, universal serial bus (USB) and other ports 232. PCI/PCIe devices 234 couples to south bridge and I/O controller hub 204 through bus 238. Hard disk drive (HDD) 226 and CD-ROM 230 couple to south bridge and I/O controller hub 204 through bus 240.

PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. Super I/O (SIO) device 236 may couple to south bridge and I/O controller hub 204.

An operating system runs on processing unit 206. This operating system coordinates and controls various components within data processing system 200 in FIG. 2. The operating system may be a commercially available operating system, such as Microsoft® Windows XP®. (Microsoft® and Windows XP® are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Storage devices, such as hard disk drive 226 store the instructions for the operating system, the object-oriented programming system, and applications or programs. Main memory 208 contains these instructions and processing unit 206 executes the instructions located in main memory 208. Processing unit 206 may perform the processes of the illustrative embodiments, using computer implemented instructions, which a memory contains. An example of a memory is main memory 208, read only memory 224, or in one or more peripheral devices.

The hardware shown in FIG. 1 and FIG. 2 may vary depending on the implementation of the illustrated embodiments. Other internal hardware or peripheral devices, such as flash memory, equivalent non-volatile memory, or optical disk drives and the like, may substitute or supplement the hardware depicted in FIG. 1 and FIG. 2. Additionally, the processes of the illustrative embodiments may run in a multiprocessor data processing system.

Specific implementations may vary the systems and components from the illustrative examples shown in FIG. 2. In some illustrative examples, data processing system 200 may be a tablet computer or a laptop computer.

Specific implementations can also vary other components from the illustrative examples shown in FIG. 2. For example, one or more buses may comprise a bus system, such as a system bus, an I/O bus, and a PCI bus. Any suitable type of communications fabric or architecture that provides for a transfer of data between different components or devices attached to the fabric or architecture may form the bus system. Additionally, a communications unit may include one or more devices used to transmit and receive data, such as a modem or a network adapter. Further, a memory may be, for example, main memory 208 or a cache such as in north bridge and memory controller hub 202. Also, a processing unit may include one or more processors or CPUs.

The depicted examples in FIG. 1 and FIG. 2 do not imply architectural limitations. In addition, the illustrative embodiments provide for a computer implemented method, apparatus, and computer-usable program code for compiling source code and for executing code. A data processing system, such as computer 100 shown in FIG. 1 or data processing system 200 shown in FIG. 2, may perform the methods described with respect to the depicted embodiments.

Circuit designers use circuit design tools, which are software applications, for designing circuits. Circuit design and synthesis software is a name for these circuit design tools. The circuits may be of many types, including logic circuits. Once the design of the circuit is complete, the circuit designers then test the design for compliance with the design parameters. Design parameters are specifications for the circuit being designed. The design of the circuit should produce a circuit that meets those specifications. Some examples of the circuit specifications, and consequently design parameters, are the timing of the circuit, delay in a gate, and slew rate. Many other types of specifications are possible for a given circuit.

The design of a circuit may contain errors. In the illustrative embodiments, errors can be broadly classified into two groups—faulty logic in the design, and design performance falling outside of design parameters. A faulty logic in the design may produce an incorrect signal at some component in the circuit. Consequently, the circuit as designed may perform the logical computation incorrectly.

A circuit as designed may also fail to meet the design parameters. For example, the circuit in the form of a processor may be too slow. With this example, the processor's specification may call for operation at 2 GHz, but the circuit may only operate at 1.8 GHz as designed. As another example, a logic component within the circuit may have a longer delay that permitted, causing the next cone of logic that accepts the output of the logic component as input to produce incorrect result.

A cone of logic is the grouping of logical components that can be grouped together as performing a part of the logical computation. Thus, just as a logic component accepts a set of inputs and produces a set of outputs, a cone of logic can be viewed as collectively accepting a set of inputs and producing a set of outputs. A set of inputs is one or more inputs. A set of outputs is one or more outputs.

Typically, a circuit design originates in code that is written in a programming language, and produces a set of photolithographs. A photolithograph is a photographic image of one or more semiconductor layers reflecting the design of those layers. The semiconductor layers contain the subcomponents of the logic components and other circuit components that together constitute the circuit.

The semiconductor manufacturing process uses the photolithographs in manufacturing those semiconductor layers onto the semiconductor material. A set of photolithographs is one or more photolithographs. The set of photolithographs that can be released for manufacturing or fabricating the circuit onto semiconductor chips are called RIT-A in the semiconductor industry. The term RIT-A stands for Release Interface Tape A. RIT-A photolithographs contain descriptions of the non-metallic layers used in forming the circuit on the semiconductor material.

Occasionally, an error in a circuit design may escape notice until after the RIT-A photolithographs are ready. RIT-A photolithographs are time consuming and expensive to remake. Generally, circuit designers avoid having to make changes to correct the error in a way that requires a new RIT-A.

RIT-B is a set of photolithographs that contain the images of the metallic layers. The metallic layers normally include the wiring of the various circuit components formed using the RIT-A photolithographs. The RIT-A and RIT-B photolithographs are used together for fabricating the logic circuits.

As compared to RIT-A, RIT-B is a less expensive way of making modifications to a circuit. RIT-B photolithographs use the metallic layers to fabricate logic components used in the modified logic circuit.

In the design of a semiconductor chip, there are areas on the semiconductor chip that are called filler cells. Filler cells are areas on the semiconductor chip that are empty and do not contain functioning components in the original design of a circuit. Some portions of the filler cells exist in RIT-A photolithographs, and other portions exist in the RIT-B photolithographs. RIT-B photolithographs use the filler cells in addition to the metallic layers for fabricating the logic components used in the modified logic circuit. By altering those portions of the filler cells that exist in the RIT-B photolithographs, circuit designers can change those filler cells from a component with no logical function, into a functioning logic gate.

Presently, when a circuit designer has to modify a circuit design, the circuit designer has to manually design the modified logic circuit and release the modified logic circuit as RIT-B. The circuit designer has to identify the error, design the logic circuit that corrects the error, and modify the circuit design to include the error correcting the logic circuit. The circuit designer then has to ensure that the modified circuit design actually corrects the error and still meets the design parameters.

Illustrative embodiments recognize that currently circuit designers use manual design processes to modify existing circuit designs. These manual design processes can be time consuming and error prone. As a practical matter, a manual design process can become difficult to manage as the error correcting logic circuit approaches approximately thirty gates. Depending on the circuit designer, more or less number of gates can present the manageability problem in modifying existing logic circuits.

Furthermore, the illustrative embodiments recognize that the manual modification of logic circuit can introduce new errors in the design. Risk of introducing new errors drives longer testing, and causes production delays.

Thus, an automated method and apparatus for modifying existing logic circuit design will be useful. The automated method and apparatus can eliminate or reduce the risk of errors, reduce design modification time, and may even produce better modification designs as compared to the manual process. The illustrative embodiments described below provide such a method and apparatus for modifying existing logic circuit designs.

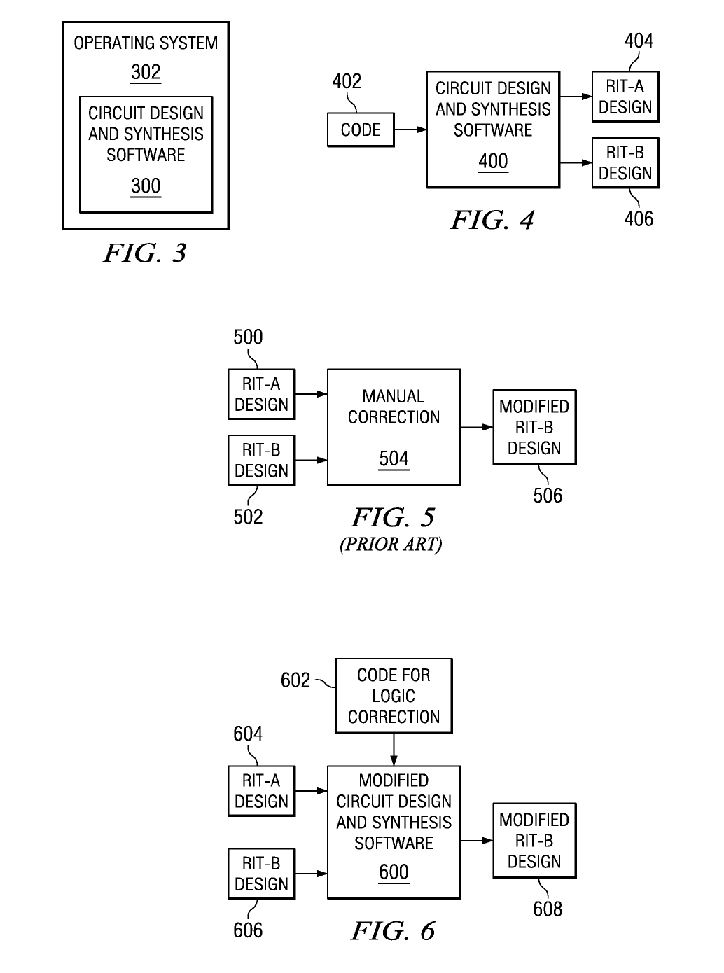

With reference now to FIG. 3, the figure depicts a block diagram of circuit design and synthesis software in accordance with an illustrative embodiment. Circuit design and synthesis software 300 is a circuit design tool and runs in operating system 302. Operating system 302 can be an operating system running on a data processing system such as computer 100 in FIG. 1.

FIG. 3 depicts circuit design and synthesis software 300 as running under a single operating system only as exemplary, and is not limiting on the illustrative embodiments. Software tools comparable to circuit design and synthesis software 300 may run under multiple operating systems, which may be geographically disperse, such as in a distributed computing environment, without departing from the scope or spirit of the illustrative embodiments.

With reference now to FIG. 4, the figure depicts a block diagram showing the manner of use of circuit design and synthesis software in accordance with an illustrative embodiment. Circuit design and synthesis software 400 may be implemented using circuit design and synthesis software 300 in FIG. 3.

In operation, circuit design and synthesis software 400 accepts code 402 as the code describing the design of the circuit. Circuit design and synthesis software 400 then produces RIT-A design 404, and RIT-B design 406.

Code 402 is a program code and describes the hardware of the circuit that the circuit designer intends to design. Languages such as VHDL and Verilog are examples of programming languages that facilitate the description of hardware. These types of languages are commonly used for writing code, such as code 402. The languages listed above are only exemplary and not limiting on the illustrative embodiment. One may use other comparable languages for code 402 without departing from the scope or spirit of the illustrative embodiment.

RIT-A design 404 is a part of the circuit design that can be produced in the form of RIT-A photolithographs as described above. RIT-B design 406 is a part of the circuit design that can be produced in the form of RIT-B photolithographs as described above.

Generation of photolithographs is manufacturing process specific. Accordingly, the particular nomenclature used in a specific manufacturing process may differ from the nomenclature of RIT-A and RIT-B described above. However, the concept of grouping non-metallic and metallic layers photolithographs is a common practice in the semiconductor industry.

Therefore, specific implementations of the illustrative embodiment may group photolithographs differently according to the nature of the layers the photolithographs depict, without departing from the scope and spirit of the illustrative embodiment. The illustrative embodiments use RIT-A and RIT-B nomenclature for the clarity of the description below.

With reference now to FIG. 5, the figure depicts a block diagram of a manual process of modifying an existing circuit design that circuit designers presently use. RIT-A design 500 can be RIT-A design 404 FIG. 4. RIT-B design 502 can be RIT-B design 406 in FIG. 4.

Manual correction 504 is the manual design process that circuit designers presently use for correcting errors in an existing circuit after the circuit design has been produced in the form of RIT-A and RIT-B photolithographs. Using RIT-A design 500 and RIT-B design 502 into the process of manual correction 504, a circuit designer produces modified design 506. Modified design 506 is the modification of the existing circuit design reflected in RIT-A design 500 and RIT-B design 502. Circuit designers generally implement modified design 506 using RIT-B photolithographs.

With reference now to FIG. 6, the figure depicts a block diagram of a modified circuit design and synthesis software in accordance with an illustrative embodiment. Modified circuit design and synthesis software 600 can be implemented using circuit design and synthesis software 400 in FIG. 4.

Presently available circuit design and synthesis software facilitate the initial circuit design suitable for generating RIT-A and RIT-B photolithographs. However, the present process for modification of circuit designs using the circuit design and synthesis software is a manual process as described with respect to FIG. 5 above. In contrast, modified circuit design and synthesis software 600 is a modification of the circuit design and synthesis software presently available such that a circuit designer can modify an existing circuit design by using the modified features of the software instead of performing the modification manually.

The part of the design that is reflected in RIT-A photolithographs contains netlists for the layout of the circuit components at the non-metallic layer levels. This part of the design includes information about specific points in the circuit design called hooks or anchor points. Hooks, or anchor points, are locations in the circuit design where certain signals may be available, and certain components may be accessible. For example, an anchor point may be a point of connection in the circuit where a specific output signal of a portion of the logic computation is available. If further logic computation has an error in the circuit as designed, this exemplary anchor point can serve as the input to a replacement logic circuit that corrects the error.

The part of the design that is produced in RIT-B photolithographs contains netlist for the layout of the circuit components at the metallic layer levels. This netlist includes the components and metallic layers that can be formed into simple logic circuits that may be inferior to the same logic circuit if implemented in the RIT-A design. This netlist further includes information about filler cells that can be formed into logic circuits in a similar manner.

In accordance with the illustrative embodiment, modified circuit design and synthesis software 600 accepts code for logic correction 602 as an input. Code for logic correction 602 can be a code in a programming language that a circuit designer writes, or a code generation software produces based on a circuit designer's instructions. Code for logic correction 602 is a code in a hardware description language, such as VHDL or Verilog, similar to code 402 in FIG. 4. However, code for logic correction only pertains to the logic circuit that is needed to correct an identified error in the existing circuit design.

In addition, modified circuit design and synthesis software 600 accepts RIT-A design 604 and RIT-B design 606 as additional inputs. RIT-A design 604 and RIT-B design 606, which are the additional inputs, are designs of the various layers of the circuit prior to the current modification. Using the three inputs 602-606, modified circuit design and synthesis software 600 identifies the anchor points in the existing circuit design where the logic circuit described in code for logic correction 602 can be implemented. For example, code for logic correction 602 may specify anchor points, or RIT-A design 604 and RIT-B design 606 may mark anchor points. Furthermore, anchor points can be computed based on other criteria, such as by specifying that a point in the circuit, where a specific output or a logical value is present, is an anchor point.

Modified circuit design and synthesis software 600 then produces modified RIT-B design 608, which is a modification of the existing circuit design that can be implemented using RIT-B photolithographs. In producing, or synthesizing, the modification of the existing circuit design in this manner, modified circuit design and synthesis software 600 utilizes the information about anchor points from RIT-A design 604 as if they are inputs and outputs of a new design. Modified circuit design and synthesis software 600 uses the metallic layers information and information about the filler cells as the material available for synthesizing the gates needed for implementing code for logic correction 602.

Occasionally, a RIT-A and RIT-B design may include information about gates that were originally present in the design but for some reason were later disconnected from the circuit. Circuit designer may disconnect parts of a circuit for a variety of reasons, such as redesign, eliminated functionality, changed specification. For example, a previous modification of the circuit may result in disconnecting a part of the circuit. The disconnected part may include components, such as gates, that are no longer used in the circuit. Some of these gates may have their inputs and outputs situated in a manner that makes the reuse of the gates for a later modification convenient. A component situated in this manner in a disconnected part of a design is called a disconnected component.

Additionally, modified circuit design and synthesis software 600 may reuse such disconnected components, gates, and other disconnected parts of the circuit. For example, modified circuit design and synthesis software 600 may determine that a NAND gate is needed in the synthesis of the modification logic circuit according to code for logic correction 602. Suppose a disconnected NAND gate is available in the RIT-A design 604 such that the disconnected NAND gate can be connected into the modification logic circuit.

A circuit designer can fabricate a NAND gate, such as by converting a filler cell into a NAND gate through changes in the metallic layers in the RIT-B photolithographs. Gates fabricated by converting filler cells are generally inferior in performance as compared to similar gates fabricated in the initial RIT-A Design. Thus, in the example above, instead of converting a filler cell into a NAND gate, modified circuit design and synthesis software 600 may reuse the disconnected NAND gate.

Modified circuit design and synthesis software 600 then enables the testing of the modification logic circuit thus synthesized. For example, a circuit designer may test the modification logic circuit to determine any adverse effects of the modification on other parts of the circuit. A circuit designer may also test the modification logic circuit to determine whether the overall modified characteristics of the changed design meet the design parameters of the circuit. Depending on the results of the testing, a circuit designer can make further modifications to ensure compliance with the design parameters. Thus, using the information provided in code for logic correction 602, RIT-A design 604, and RIT-B design 606, modified circuit design and synthesis software 600 produces modified RIT-B design 608 that can be implemented by modifying RIT-B photolithographs.

A changed design is the previous design of the circuit as modified by the modification design. Note that the modification design is the design of the modification logic circuit, whereas the changed design is the overall design of the circuit as modified by the modification design.

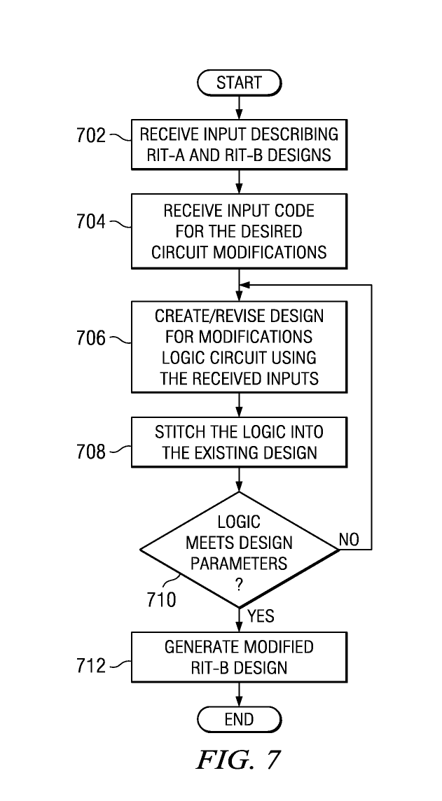

With reference now to FIG. 7, this figure depicts a flowchart of the process of modifying an existing circuit design in accordance with an illustrative embodiment. The process of FIG. 7 can be implemented in modified circuit design and synthesis software 600 in FIG. 6.

The process begins by receiving an input describing RIT-A and RIT-B designs (step 702). The process also receives input code for the desired circuit modifications (step 704). Note that steps 702 and 704 may be combined, further subdivided, or performed in other ways in other order without departing from the scope and spirit of the illustrative embodiment.

Next, the process creates a design for a modification logic circuit using the received inputs (step 706). The process then “stitches” the design of the modification logic circuit into the existing circuit design (step 708). Stitching the design of the modification logic circuit into the existing circuit design is the process of integrating the design of the modification logic circuit and the existing circuit design in order to achieve the desired correction in the logic of the overall circuit. The design of the overall circuit stitched in this manner is called a stitched circuit design.

Next, the process determines if the stitched circuit design meets the design parameters (step 710). Note that the stitched circuit represents the changed design as described above. If the stitched circuit design does not meet the design parameters (“no” path of step 710), the process repeats step 706 and revises the design for the modification logic circuit. The process then performs step 708 again and repeats making the determination of step 710.

The process continues in this manner until the stitched circuit design meets the design parameters (“yes” path of step 710). The process then generates a modified design that can be implemented using RIT-B photolithographs (step 712). The process ends thereafter.

Thus, the illustrative embodiments provide a method and apparatus for modifying existing circuit designs without requiring manual design of modification logic circuit. When a circuit designer has to modify a design of a circuit, the circuit designer codes the modification. Using the code, in combination with the existing design of the metallic and nonmetallic layers of the circuit, a modified circuit design tool identifies hooks, filler cells, and disconnected components in the existing design of the circuit. The modified circuit design tool then produces a modification design that can be implemented in a revised design of the plurality of the metallic layers of the circuit.

In this manner, the illustrative embodiments modify the circuit design process implemented in presently available circuit design and synthesis software for designing the modification logic circuit. Modified circuit design and synthesis software is then able to stitch the modified logic circuit into the existing circuit design for correcting errors in the existing circuit design.

Modified circuit design and synthesis software according to the illustrative embodiments provides capabilities for testing and revising the synthesized design of the modification logic circuit such that the design parameters are met. Furthermore, the modified circuit design and synthesis software according to the illustrative embodiments produces a modification design, which is the design of the modification logic circuit. The modification design is stitched into the existing circuit design, forming a changed design of the circuit. The changed design is released as RIT-B photolithographs. The RIT-B photolithographs containing the modification design and the previously available RIT-A photolithographs together can then be used in fabrication of the chip.

Furthermore, the illustrative embodiments include the capability for re-using disconnected logic components from the RIT-A design, into the design of the modification logic circuit. Therefore, the illustrative embodiments provide a method and apparatus for modifying an existing circuit design that are less error prone, less time consuming, and parallel to the original design process, than the presently used manual modification process.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times, code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for modifying an existing circuit design, the computer implemented method comprising:
responsive to a request for a modification in a design of a circuit, receiving, in a circuit design tool, a code describing the modification;
receiving, in the circuit design tool, the design of the circuit, wherein the design of the circuit comprises a first design, wherein the first design comprises a design for a plurality of metallic layers in the circuit, and a second design, wherein the second design comprises a design for a plurality of non-metallic layers in the circuit;
identifying, in the circuit design tool, a set of hooks in the design of the circuit;
identifying, in the circuit design tool, a set of disconnected components in the design of the circuit;
identifying, in the circuit design tool, a set of filler cells in the design of the circuit; and
producing, in the circuit design tool, a modification design using the code, a subset of the set of hooks, a subset of the set of disconnected components, and a subset of the set of filler cells, wherein the modification design is implemented in a revision of the first design.

2. The computer implemented method of claim 1, further comprising:
connecting, in the circuit design tool, the modification design with the design of the circuit to form a changed design of the circuit, the changed design of the circuit corresponding to the modification in the design of the circuit in the request.

3. The computer implemented method of claim 2, further comprising:
testing, in the circuit design tool, the changed design of the circuit to determine if the changed design of the circuit corresponds to a set of design parameters.

4. The computer implemented method of claim 2, further comprising:
revising the changed design of the circuit in the circuit design tool, wherein the revising occurs if the changed design of the circuit does not correspond to a set of design parameters.

5. The computer implemented method of claim 1, wherein the code is one of VHDL code and Verilog code.

6. The computer implemented method of claim 1, wherein an existing computer implemented method of circuit design is modified to include the receiving steps, the identifying steps, and the producing step.

7. The computer implemented method of claim 3, wherein an existing computer implemented method of circuit design is modified to include the testing step.

8. The computer implemented method of claim 4, wherein an existing computer implemented method of circuit design is modified to include the revising step.

9. An apparatus for modifying an existing circuit design, the apparatus comprising:
a data processing system, wherein the data processing system comprises:
a circuit design tool, wherein responsive to a request for a modification in a design of a circuit, the circuit design tool receives a code describing the modification, wherein the circuit design tool receives the design of the circuit, wherein the design of the circuit comprises a first design, wherein the first design comprises a design for a plurality of metallic layers in the circuit, and a second design, wherein the second design comprises a design for a plurality of non-metallic layers in the circuit, wherein the circuit design tool identifies a set of hooks in the design of the circuit, wherein the circuit design tool identifies a set of disconnected components in the design of the circuit, wherein the circuit design tool identifies a set of filler cells in the design of the circuit, wherein the circuit design tool produces a modification design using the code, a subset of the set of hooks, a subset of the set of disconnected components, and a subset of the set of filler cells, and wherein the modification design is implemented in a revision of the first design.

10. The apparatus of claim 9, wherein the circuit design tool connects the modification design with the design of the circuit to form a changed design of the circuit, the changed design of the circuit corresponding to the modification in the design of the circuit in the request.

11. The apparatus of claim 10 wherein the circuit design tool tests the changed design of the circuit to determine if the changed design of the circuit corresponds to a set of design parameters.

12. The apparatus of claim 10, wherein the circuit design tool revises the changed design of the circuit, wherein the revising occurs if the changed design of the circuit does not correspond to a set of design parameters.

13. The apparatus of claim 9, wherein the code is one of VHDL code and Verilog code.

14. The apparatus of claim 9, wherein an existing circuit design tool is modified to form the circuit design tool with capability to receive the code describing the modification, capability to receive the design of the circuit, capability to identify the set of hooks, capability to identify the set of disconnected components, capability to identify the set of filler cells, and the capability to produce the modified design.

15. The apparatus of claim 11, wherein an existing circuit design tool is modified to include the capability to test the changed design of the circuit.

16. The apparatus of claim 12, wherein an existing circuit design tool is modified to include the capability to revise the changed design of the circuit.
